(19) United States
(12) Patent Application Publication
(10) Pub. No.: US 2025/0055584 A1
(43) Pub. Date: Feb. 13, 2025

(54) WIRELESS COMMUNICATION AND DETECTION DEVICE SELECTION AND WEIGHT OPTIMIZATION METHOD FOR COMBINED OBJECT DETECTION AND TRACKING

(71) Applicant: ISTANBUL MEDIPOL UNIVERSITESI, Istanbul (TR)

(72) Inventors: Halise TÜRKMEN, Istanbul (TR); Talha YILMAZ, Istanbul (TR); Ebubekir MEMISOGLU, Istanbul (TR); Hüseyin ARSLAN, Istanbul (TR)

(21) Appl. No.: 18/718,382

(22) PCT Filed: Dec. 7, 2022
(86) PCT No.: PCT/TR2022/051429

§ 371 Date: Jun. 10, 2024

(30) Foreign Application Priority Data
Dec. 10, 2021 (TR) 2021/019625

(51) Int. Cl. H04B 17/309; H04B 17/15

(52) U.S. Cl. CPC H04B 17/346; H04B 17/15

(57) ABSTRACT

Disclosed is to an algorithm that will increase the performance of detection processes to be performed in next generation communication systems and a method using this algorithm. The algorithm optimizes the detection performance based on the SINK values of the signals sent and reflected by the wireless communication or detection communication devices in the environment and selects the wireless communication or detection device(s) to be used to detect that object.

### TECHNICAL FIELD

The present invention relates to an algorithm that will increase the performance of wireless detection processes to be performed in next-generation communication systems and a method using this algorithm. The algorithm of the invention optimizes the detection performance based on the SINR values of the signals sent and reflected by the wireless communication or detection communication devices in the environment and selects the wireless communication or detection device(s) to be used to detect that object.

### STATE OF THE ART

In the new generation communication systems (5G, 6G, vehicle-to-vehicle communication, new generation Wi-Fi standards, etc.), wireless detection is required along with communication. Wireless detection can be used in various ways such as radar, smart home applications, and improving communication performance. The performance of this wireless detection directly affects the performance of new application areas where new-generation communication technologies will be used.

In the literature, it has been researched how to improve communication performance by combining the data received from more than one device and solutions have been developed for this issue. Similarly, in the radar literature, the way to obtain the best radar performance by combining data from more than one radar device has been researched and solutions have been presented. However, there is no solution for improving the detection performance of a communication system that intends to detect wirelessly.

Although there has been no solution for this issue directly previous to the invention, solutions for combining the data received from more than one radar device, which is the closest problem, were given in the research titles of data fusion and inter-radar transmission of the object in radar networks in the radar literature. Algorithms for the fusion of data received from devices in a radar device network created by data fusion are being developed. Examples of these algorithms can be found in the 2011 publication by Nasei, A. et al. or the 2007 publication by Shu, H., et al. An uncoordinated wireless detection process is already carried out in communication systems, but since there is no coordination, an increase in performance cannot be achieved as intended by the invention.

The solutions suggested in the technical documents are to average the data received from the devices in the radar device network, and to combine the estimation data made by each device for detection by means of majority voting or Bayesian statistics. In addition, detection estimation methods on a single device for increasing the communication performance in communication systems are also available in the literature.

Due to the nature of the devices and methods used for estimation in the radar literature, one of the most important metrics affecting estimation performance is the SNR value. Interference is not a problem in these systems because of the techniques used in the radar field and the waveform used. However, noise and interference play a serious role in the performance of the detection estimation processes carried out in the communication systems. In addition, it is assumed in the radar literature that there is a clear line of sight between the device and the target, and the interference caused by multipath is ignored. Therefore, data fusion solutions presented in the radar literature may be insufficient to improve the wireless detection performance of the communication systems.

Considering the state of the art in this regard, there is a need for a method that will increase the performance of wireless detection processes in communication systems.

### OBJECTS OF THE INVENTION

It is expected that future wireless communication systems will be able to perform many functions besides being simple communication systems. The roles of these systems in applications such as smart environments and digital twins, city government, efficient use of environmental and ambient resources, and damage and casualty detection in disaster situations are not limited to providing wireless communication. Wireless detection, that is, the detection and identification of living and inanimate objects in the environment of electromagnetic signals (communication and/or radar signals), can be carried out with the communication infrastructures in the environment (such as Wi-Fi, cellular communication) and devices using these infrastructures (mobile phones, such as smart home appliances). New-generation communication systems are also intended to be used in critical missions. For example, a detection error in communication between vehicles can lead to serious accidents and even loss of life. Communication systems will be used for detection in many critical areas such as this one, and even in the 5G standard published by 3GPP in Rel16 and Rel17, and in LTE-Advanced, there are methods to increase wireless detection performance for device positioning. In addition, it established the 802.11bf task group within the IEEE Standards Association 802.11 Working Group for the standardization of Wi-Fi detection.

It is obvious that the detection performance in communication systems in general has an important role in the overall performance of the system and in the realization and commercialization of smart and secure applications that increase the quality of life. Therefore, improving the detection performance of communication systems with the present invention is the primary goal. For this purpose, it is thought that the construction of new-generation communication tools with higher detection performance will contribute to the success of the intended mission, and it will also show a considerable benefit in terms of ensuring the safety of people's life and health according to the criticality of the mission.

### BRIEF DESCRIPTION OF THE INVENTION

The present relates to a method that will increase the performance of wireless detection processes in wireless communication systems, and the said method comprises the following steps:
i. Retrieving the detection data and SINR information from all detection devices (200)
ii. Assigning appropriate weights (α) to the detection data sent by each device according to the SINR information received from the detection devices (201)
iii. Comparing the assigned weights (α) with a predetermined threshold value (α_{threshold}) (202);
iv. If α_{threshold}>α for any assigned α (205), the devices whose weight is below the threshold value being excluded from the process, and these devices being turned off for detection,
v. If α_{threshold}<α for all assigned α values (206); combining data from the detection data using their assigned weights for best results.

The method according to the invention has the advantages of (i) improving detection processes by using metrics calculated and used entirely in the communication systems, (ii) realizing improved detection of wireless detection targets in a coordinated manner so that no extra signal generation is required for detection.

In addition, optimization is made in the radar literature by using different radar devices in a way that does not interfere with each other. However, in communication systems, the channel causes interference according to the distance and speed of the object to be detected. (inter-symbol interference (ISI) and inter-carrier interference (ICI)) Considering the effects of this interference in order to improve the detection estimation, the signal received from each communication device is predominantly collected by the method according to the invention.

Other advantages of the method according to the present invention are the fact that it can be easily adapted to coordinated communication systems and provides the ability to improve performance without making any other estimation than the estimation processes normally made in the communication systems.

### DESCRIPTION OF THE FIGURES

FIG. 1: Default problem scenario

100: Communication device

101: Reflected communication signal

102: Communication protocol

103: Control center that does the combination work

104: Object to be detected

FIG. 2: Flow chart of the algorithm according to the invention

200: Retrieving the detection data and SINR information from all detection devices

201: Assigning appropriate weights to the detection data sent by each device according to the SINR information received from the detection devices.

202: Comparing the assigned weights with a predetermined threshold value.

203: Combining data from the detection data using their assigned weights for best results.

204: Removing devices whose weight is below the threshold value from the process and turning these devices off for detection.

205: If α_{threshold}>α for any assigned α

206: If α_{threshold}<α for all assigned α values

A: Start

B: End

### DETAILED DESCRIPTION OF THE INVENTION

The present invention relates to a method that will increase the performance of wireless detection processes in wireless communication systems, and the said method comprises the following steps:
i. Retrieving the detection data and SINR information (200) from all detection devices (100)
ii. Assigning appropriate weights (α) to the detection data sent by each device according to the SINR information received from the detection devices (201)
iii. Comparing the assigned weights (α) with a predetermined threshold value (202);
iv. If α_{threshold}>α for any assigned α (205), the devices whose weight is below the threshold value being excluded from the process, and these devices being turned off for detection (204),
v. If α_{threshold}<α for all assigned α values (206); combining data from the detection data using their assigned weights for best results (203).

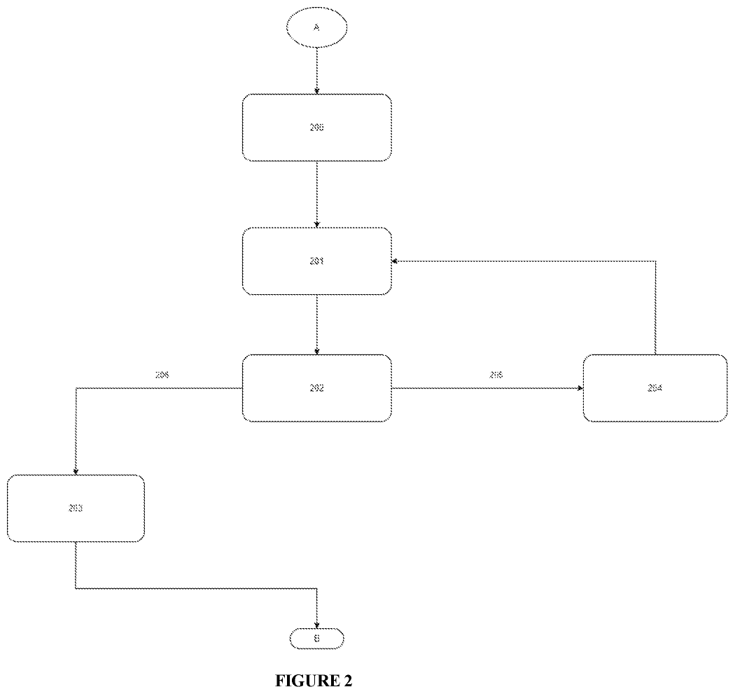

The process of receiving detection data and SINR information from all sensor devices in the method according to the invention (200) is initiated by receiving the detection data and performance metric over any communication protocol (102). The method according to the invention is explained with the flow chart in FIG. 2, the details of which are given below.

“Detection device” and “communication devices” used within the scope of the invention and the reference number (100) used together with these terms mean wireless detection devices, they have the same meaning and can be used interchangeably in the text. Similarly, the reference numbers given in the description of the figures above can be used alone in the text to express the description next to them.

The wireless communication system mentioned within the scope of the invention is a new-generation communication system in a preferred application of the invention. The expression “next generation communication systems” used within the scope of the invention refers to any communication system that includes the use of CoMP (Coordinated Multi Point) communication networks in new standards such as 5G, 6G, and Wi-Fi 7. In addition, the expression “next-generation communication systems” can be any of the new communication systems defined above, and any of the old and present communication systems where the necessary coordination for the application of the method according to the invention can be achieved.

Within the scope of the invention, any performance metric based on SINR and/or SINR is taken as a performance metric.

Although it is stated that the SINR-based performance metric was chosen in the invention, the method according to the invention has the feature of being applicable not only to the SINR-based performance metric but also to other metrics used in the communication systems or obtained from the communication signal.

Preferably using SINR in the method according to the invention has some technical benefits, since symbols are not expected to interfere with each other in radar systems, and the types of interference mentioned here can be, for example, ISI, which is the inter-symbol interference and/or ICI, which is the inter-carrier interference. ISI occurs due to the channel's multipath effect, while ICI occurs due to the channel's doppler propagation effect on the signal. The ICI effect occurs in multi-carrier systems. For single carrier systems, the effect of doppler propagation on the communication signal is called ACI (Adjacent Channel Interference) neighbor channel interference. In single-carrier systems, different users separated by using frequencies perpendicular to each other can cause interference with each other due to the Doppler effect. There are many methods used in communication systems to eliminate interference caused by this type of channel. However, when the same communication signal is used for detection, it is exposed to a different channel than the channel to which the communication signal is exposed. This is because the reflection signal used for detection makes a round trip. Therefore, the interference removal techniques used in communication systems can sometimes be insufficient for the wireless detection signal or increase the operational complexity too much. Therefore, the proposed algorithm to reveal a combination of information according to the SINR value provides a performance increase without the need for too complex operations, considering this present interference.

Mathematically, SINR is defined as follows:

$$SINR = \frac{S}{I + N}$$

In this equation, S is the signal power, I is the interference power, and N is the noise power.

In the radar literature, SNR is used as a performance criterion since the systems are designed to work without interference. SNR is as follows:

$$SNR = \frac{S}{N}$$

In the further steps of the algorithm, a direct link will be established between the SINR and the performance of the estimation process. In order to have a concrete example in the reader's mind during the explanation of the algorithm, the performance metric will be considered SINR. However, the invention is not limited to the SINR metric.

The process of assigning appropriate weights to the detection data sent by each device based on the SINR information received from the detection devices (201) in the method according to the invention is performed by using the SINR values obtained in step (200) for the weight assignment process of receiving the detection data and SINR information from all detection devices.

The reason for this is that the SINR value directly affects the estimation performance. The most commonly used method in the literature for detection estimations is the maximum likelihood estimation, which is called MLE for short. The lowest error margin that will occur when infinite samples are taken for estimation in MLE is called Cramer-Rao Lower Bound (CRLB). This margin of error is inversely proportional to the SINR, or mathematically:

$$CRLB ∝ \frac{1}{SINR}$$

This fact shows that the estimation made on a signal with a physically high SINR is closer to the true value of the parameter, or the estimation made in a simpler way is more reliable. However, this interference may lead to bad results for some devices, while it may have a positive effect on others. Therefore, instead of using only the device with the highest SINR value, in the proposed algorithm, weights are assigned according to the SINR values, expecting an increase in performance by combining information and creating data diversity.

Different signal processing techniques can be considered for weight assignment. The method proposed in this form for the explanation of the algorithm is to normalize all the SINR values received and determine the weights so that the total SINR value is 1. This can be done step by step as follows:
1. Converting SINR values from logarithmic base to decimal base.

$${SINR}_{{decimal}_{n}} = {10}^{\frac{{SINR}_{{dB}_{n}}}{10}}$$

2. Calculating the total SINR value in decimal base:

$${SINR}_{total} = {\sum }_{n} {SINR}_{{decimal}_{n}}$$

3. Determining the weights by dividing each SINR value by the total SINR value

$${α}_{n} = \frac{{SINR}_{{decimal}_{n}}}{{SINR}_{total}}$$

In this way, a higher weight will be given to the detection data with a high SINR value. As noted earlier, other methods for determining weights can be considered and adapted. Physically, this actually means that since the signal is stronger, the detection data from this signal is more reliable than others, even if it is not perfect. Rather than using only this data, combining all detection data by weight increases the diversity of information and provides a more accurate detection result.

In step (202) of comparing the assigned weights in the method according to the invention with a predetermined threshold value, it is intended to continue with steps 203 or 204 based on the result obtained by comparing the weights assigned to the detection data in step 201 with a predetermined threshold value.

The threshold value is the weight size obtained in order to ensure that the data is definitely not processed if the performance metric is below the desired value according to the application. The weights physically represent the reliability of the data. If the weight assigned to data is below this predetermined threshold value, it is done in order not to process it, considering that it may have a reducing effect instead of increasing the accuracy of the data with diversity. If all weight values are above the specified threshold, the algorithm continues to step (203). If even one weight is below the specified threshold, the algorithm continues from step (204). No threshold value may have been selected specifically for the application. In this case, the algorithm will always continue from step (203). The case of not selecting any threshold value is a special case of the proposed algorithm. Another special case may be that only the device with the highest SINR value is used. in this case, selecting a high enough threshold value will ensure that the algorithm only works until the device with the highest SINR value is determined.

If α_{threshold}<α for all assigned α values in the method according to the invention (206); Since all weight values determined in step (203) of combining the data obtained from the detection data for the best result using their assigned weights are higher than the compared threshold value, it means that these weight values can be used in the data combination stage.

The detection data obtained will be multiplied and collected by the determined weight methods and the last detection data will be used. This method is referred to as the weighted sum method in the literature. The detection result obtained by this method is obtained as follows:

$$\hat{x} = {\sum }_{n} {α}_{n} {x}_{n}$$

$$\hat{y} = {\sum }_{n} {α}_{n} {y}_{n}$$

$$\hat{z} = {\sum }_{n} {α}_{n} {z}_{n}$$

$$\hat{V} = {\sum }_{n} {α}_{n} {V}_{n}$$

If α_{threshold}>α for any assigned α in the method according to the invention (205), it is understood that there is a weight or weights lower than the compared threshold value in the weight values determined in the step of removing the devices whose weight is below the threshold value from the process and turning these devices off for detection (204). In this case, the data whose weight is lower than the threshold value for the target to be detected should be excluded from use. In this case, for the system to detect efficiently, the control center should turn off the detection process for the devices that are assigned lower weights (100) for this target, and then return to step (201) and calculate the weights again without considering the low weight data. This process will continue until the most suitable weights for use in (203) are obtained.

It is possible to develop a wide variety of applications related to the subject of the invention around these basic concepts, and the invention cannot be limited to the examples described here, being essentially as stated in the claims.

It is clear that those skilled in the art can demonstrate the innovation revealed in the invention by using similar embodiments and/or can apply this embodiment to other similar fields used in the related art. Therefore, it is obvious that such embodiments will lack the criteria of innovation and especially of exceeding the state of the art.

The technical and other features mentioned in each claim are followed by a reference number, and these reference numbers are used only for a better understanding of the claims, therefore, should not be considered as limiting the scope of any of the elements indicated by these reference numbers for illustrative purposes.

### Examples

### Example 1: Problem Scenario

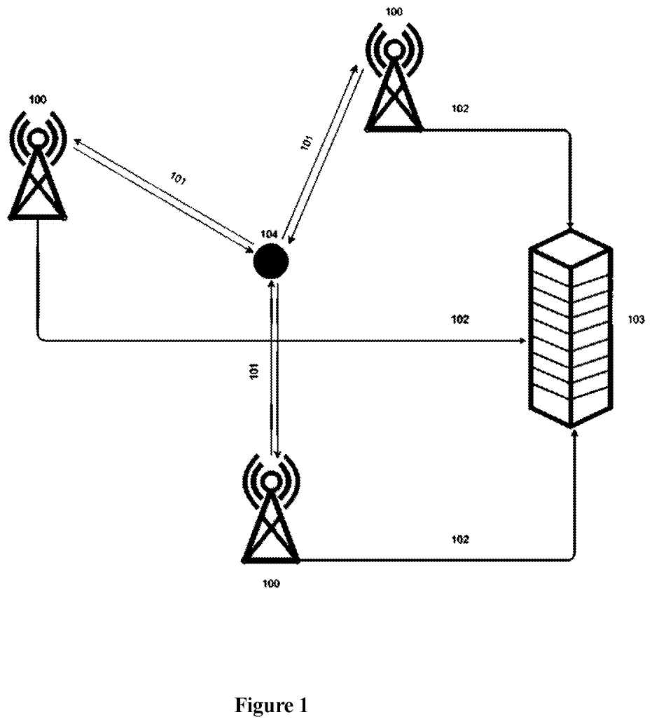

The scenario depicted in FIG. 1 illustrates three communicating devices (100). As the number of these devices is increased, it is expected that the performance increase of the proposed method will increase. Although the communicating device (100) is considered a base station in this example, it can also be any communication system that performs detection. For example, modems, communication tools, IoT devices, etc. These devices may be coordinated among themselves, or they may be working in connection with a center as shown in FIG. 102). It will try to estimate the position and absolute speed of (104) by the estimation to be made by the communicating device (100) shown in the above scenario. This estimation process makes a distance, velocity, and angle estimation by each communication device (100) according to (104) depending on its position and speed. Since there are three communication devices in the scenario, the parameters that each device estimates can be named as r₁, v₁, θ₁, r₂, v₂, θ₂, r₃, v₃, θ₃, each of which being distance, speed, and angle, respectively. While the communicating device (100) makes the position of (104) an absolute position in the coordinate plane with rₙ, θₙ parameters it estimates for itself, the absolute speed (Vₙ) of (104) is attempted to be estimated with the (xₙ, yₙ, zₙ) vₙ parameter. In this case, (xₙ, yₙ, zₙ) and Vₙ parameters from each communicating device (100) are called detection data. That is, the detection data is the absolute position and absolute velocity information obtained as a result of the estimation made by each communication device (100). The control center (103), which performs the combining work, collects these incoming detection data and performance metrics, and performs the algorithm in the presented method, trying to obtain the most accurate detection result. Detection is performed on an object to be detected, indicated by (104) in the figure. The presented algorithm is developed independently of a return from the object (104) to be detected. Therefore, the object (104) to be detected need not be an active element providing a return. The communication device (100) will send the performance metric obtained by measuring the quality of the data and signal obtained by measuring the quality of the data and signal obtained by performing the detection process within itself (101) by taking the reflected form of the communication signal emitted by the object to be detected (104) to the control center (103) for processing via the communication protocol (102).

The technical and other features mentioned in each claim are followed by a reference number, and these reference numbers are used only for better understanding of the claims, therefore, should not be considered as limiting the scope of any of the elements indicated by these reference numbers for illustrative purposes.

Within these basic concepts, it is possible to develop a wide variety of embodiments of the subject matter of the invention, and the invention cannot be limited to the examples described herein but is essentially as set forth in the claims.

It is clear that those skilled in the art can demonstrate the innovation revealed in the invention by using similar embodiments and/or can apply this embodiment to other similar fields used in the related art. Therefore, it is obvious that such embodiments will lack the criteria of innovation and especially of exceeding the state of the art.

### INDUSTRIAL APPLICABILITY

The method according to the invention is suitable for use in every system where communication and detection are performed for performance increase. Since the detection process has many uses (location detection, proximity determination, tracking, channel estimation, velocity estimation, motion recognition, etc.), the proposed algorithm has a very flexible application area.

The method according to the invention can be used to increase the performance of the detection process if detection is desired for any purpose in new generation communication systems and if the communication devices in the developed system are to be coordinated with each other or are connected to a common control station.

The term ISI (Inter-symbol interference) used within the scope of the invention refers to inter-symbol interference and it is the name given to the interference of sent symbols with the other sent symbols due to multipath.

The term ICI (Inter-carrier interference) used within the scope of the invention refers to inter-carrier interference and it is the name given to the interference that occurs between carriers by disrupting the orthogonality between carriers, since the multi-path channel also contains the doppler effect in multi-carrier communication systems.

The term ACI (Adjacent Channel interference) used within the scope of the invention refers to the interference of the side channels assigned to different users between each other.

The term MLE (Maximum Likelihood Estimation) used within the scope of the invention refers to the estimation method made by maximizing the function called the “Likelihood function.”

1. A method that will increase the performance of detection processes to be performed in wireless communication systems, and the said method comprises the following steps:
i. Retrieving the detection data and SINR information from all detection devices (200);
ii. Assigning appropriate weights (α) to the detection data sent by each device according to the SINR information received from the detection devices (201);
iii. Comparing the assigned weights (α) with a predetermined threshold value (α_{threshold}) (202);
iv. If α_{threshold}>α for any assigned α (205), the devices whose weight is below the threshold value being excluded from the process and these devices being turned off for detection (204);
v. If α_{threshold}<α for all assigned α values (206); combining data from the detection data using their assigned weights for best results (203);

2. A method according to claim 1, wherein the detection data and performance metric are received via the communication protocol (102) in step (i).

3. A method according to claim 2, wherein the performance metric is any signal-noise ratio (SINR) and/or SINR based performance metric.

4. A method according to claim 3, wherein characterized in that the weights are determined based on the received SINR values for the weight assignment process in step (ii).

5. A method according to claim 4, characterized in that the weight assignment process in step (ii) comprises the following steps:
converting SINR values from logarithmic base to decimal base;
$${SINR}_{{decimal}_{n}} = {10}^{\frac{{SINR}_{{dB}_{n}}}{10}}$$
calculating the total SINR value in decimal base:
$${SINR}_{total} = {\sum }_{n} {SINR}_{{decimal}_{n}}$$
determining the weights by dividing each SINR value by the total SINR value.
$${α}_{n} = \frac{{SINR}_{{decimal}_{n}}}{{SINR}_{total}}$$
